(19) United States
(12) Patent Application Publication
(10) Pub. No.: US 2022/0035862 A1
(43) Pub. Date: Feb. 3, 2022

(54) CONTEXT ENRICHED DATA FOR MACHINE LEARNING MODEL

(71) Applicant: jSonar Inc., San Mateo, CA (US)

(72) Inventor: Ron Ben-Natan, Lexington, MA (US)

(21) Appl. No.: 16/224,915

(22) Filed: Dec. 19, 2018

(51) Int. Cl. G06F 16/906; G06N 20/00; G06K 9/62; G06F 21/62

(52) U.S. Cl. CPC G06F 16/906; G06F 21/6245; G06K 9/6256; G06N 20/00

(57) ABSTRACT

A data store classification approach identifies metadata and contextual aspects of data that extend beyond the mere content or label of the data to examine organizational, locational, and proximity features that tend to suggest whether a data item may or may not be sensitive. These aspects place the data in a context around which inferences of sensitivity may be derived by a machine learning representation or similar configuration. Features and corresponding attributes of the data items are derived and associated with the data by a model. The model defines an enriched data representation of the data in conjunction with the attributes that indicate a sensitive data item. The attributes and data items can be evaluated as to whether or not a data item is a sensitive or private data item so that relevant decisions about privacy and security may be made.

### BACKGROUND

Data security and privacy have become an increasingly significant aspect to automated information processing in recent decades. Continual advances in information storage and computing resources for manipulating the information allow greater quantities of information about people and enterprises to be rapidly accessed. These advances are also marked by unscrupulous usage of the data in the same expeditious manner. Accordingly, privacy concerns over access to sensitive and private data is a major concern to entities charged with safeguarding this information. This information often falls into the category of Personal Identification Information (PII) or Non-Public Information (NPI). Often being of a financial nature, but also including other personal details, sensitive data remains an ongoing liability concern as a breach of this stored data can incur reparation and remediation costs by the safeguarding entity.

### SUMMARY

A data sensitivity classification approach identifies metadata and contextual aspects of data that extend beyond the mere content or label of the data to examine organizational, locational, and proximity features that tend to suggest whether a data item may or may not be sensitive. These aspects place the data in a context around which inferences of sensitivity may be derived by a machine learning (ML) representation or similar configuration. Features and corresponding attributes of the data items are derived and associated with the data by a model. The model defines the ML representation of the attributes which tend to be associated with a sensitive data item. A server or intake application generates an enriched data set including the data items with the sensitivity attributes appended or associated with the data. The server applies the model to the enriched data for evaluating whether or not a data item is a sensitive or private data item so that relevant decisions about privacy and security may be made.

A multitude of conventional security approaches purport to implement PII and NPI scanning projects. Conventional approaches scan the data repositories and markup which data is sensitive. These approaches implement expressions defining rules that are unscaleable, often defining a project that takes so long to complete that the data landscape itself changes faster so by the time the scan and processing of the repository occurs, the contents have changed and the classification data is stale.

The reason conventional systems and projects fail is that they are focused on an inefficient aspect. They are focused on the scanning approach and they expect that the scanner can identify sensitive data (e.g. an account number or an address) using methods such as matching a regular expression (regex) or matching a list of customers etc. But the reality is that all these matches have so many false positives and are so unreliable that the results have negligible value and require human review of findings. When a scan is performed on an enterprise that has 10K repositories and in each of them there are between 1K and 100K sources (tables, directories, etc.) the result is a scan that includes between 10 million and 1 billion targets. Even if there is only a 1% false positive rate (which is very low), it becomes unmanageable.

Configurations herein are based, in part, on the observation that conventional approaches to data security and privacy tend to focus excessively on the labels and content of the data while using very simplistic pattern matching rules. Conditional expressions, common in database query syntax such as SQL, are also applied in a security context to qualify the data based on Boolean logic using a regex of operands and values. Unfortunately, conventional approaches suffer from the shortcoming that regular expressions examine unitary data items in a vacuum, and do not encompass the context, such as the manner of storage or adjacency, as well as other features, that tend to weigh on the likelihood of sensitivity. Indeed, conventional approaches purport to compute a likelihood as a percentage or quantity, which fail to recognize a set of collective features from which a conclusion can be drawn. Accordingly, configurations herein substantially overcome the shortcomings of conventional regular expression security and data classification by providing a ML model of features and attributes that tend to suggest the sensitivity of a data item. The approach enriches the data items with features, then evaluates the features using the model to render an indication of whether the data item is sensitive or not.

In further detail, configurations herein depict a method for classifying data sensitivity in large data sets by identifying a set of features that define a context for a plurality of data items in the data set, such that each feature defines metadata about the form and use of the data, and determining, for each feature, a source for identifying an attribute for each feature. A server or other entity invoking the model computes, for each feature, a value for the attribute indicative of sensitive data based on referencing the source. The computed attributes are associated with each respective data item in the data set to generate an enriched data set including the attributes for each data item in the plurality of data items. From the enriched data set, the server concludes, based on the model of the features and attributes, whether the data item is a sensitive data item. Other tags that qualify the sensitivity further may also be computed.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a machine learning model for enriching data with context derived attributes suitable for use with configurations herein;

FIG. 2 is a data structure diagram of enriched data depicted in FIG. 1;

FIG. 3 is a flowchart for developing and invoking the enriched data of FIG. 2.

### DETAILED DESCRIPTION

Configurations below implement classification logic using features the define attributes for setting the data in context. A machine learning model implements the classification logic, however any suitable logic model may be employed. Data is enriched by adding or associating the data with features, and defining attributes for the features. The enriched data allows classification by the model for evaluating the sensitivity of a data item.

Sensitivity and privacy indicate a likelihood that the data item is indicative of a personal or unique fact about an entity to which it pertains.

Sensitive data includes data which, although it may be in the public domain, might tend to implicate a particular person or lead to an inference of private data in conjunction with other data items. Private data is data specific to an individual which is not in the public domain. Sensitive data about a person, entity or individual also includes private data.

A model refers to a data structure or collection of memory items operable to store information about features and attributes which tend to indicate a greater or lesser likelihood that a data item contains sensitive or private data. A training set is a set of data items having features and attributes with a known association or disassociation with a sensitive data item, and is intended to initially populate the model, to be followed by invoking the model in arriving at an accurate determination of a sensitivity for externally gathered data items.

A feature refers to a metadata or context-based fact or grouping having a relevance to the sensitivity of a data item. An attribute is a value of a feature associated with a particular data item. The attributes are obtained from sources or metadata that comprise the context of the data.

In contrast to conventional approaches, it is the relevance to collective features codified in the random forest which indicates sensitivity, rather than a numeric likelihood expressed as percentages based on inclusion or exclusion from a group. The use of a machine leaning model provides a multidimensional definition of features and attributes which suggest or point to sensitivity of a data item. The ML model can therefore collectively consider all features associated with a particular data item in concluding sensitivity and related tags.

In configurations herein, the model may be an ML representation of the features and attributes, which is configured for a random forest implementation, however alternate ML representations may also be employed.

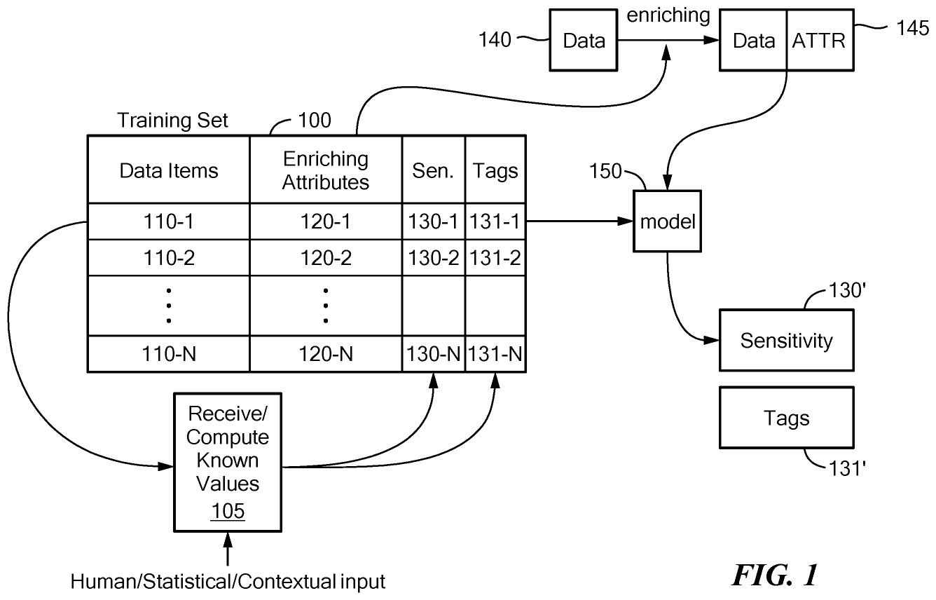

FIG. 1 is a context diagram of a machine learning model for enriching data with context derived attributes suitable for use with configurations herein. Referring to FIG. 1, an initial training set 100 includes a set of data items 110-1 . . . 110-N (110 generally). The data items may be field values, entire rows in a table, entries in a type/value arrangement, or any granularity for which a collective attribute may be applied. Each data item 110 also corresponds to one or more attributes 120-1 . . . 120-N (120 generally). Generating the training set 100 includes identifying, for each data item 110, features that define a contextual aspect of the data, such that each feature tends to have a correlation with sensitivity or privacy of the data, and for each feature, receiving an attribute 120 indicative of a sensitivity of the data item. In general, the sensitivity indicates a likelihood that the data item is indicative of a personal, unique or financial fact about an entity to which it pertains.

The training set 100 is used to train machine learning model (model) 150 by receiving sensitivity and tag values based on correct recognition of for sample data. The correct recognition 105 may be obtained from human/manual input, statistical input and contextual input. The training set 100 denotes the sources containing the features, and the attributes 120 are obtained from the sources. The attributes 120 based on the features define the enriched data set. From the enriched data set, by examining both the data and the attributes, a sensitivity determination 130-1 . . . 130-N (130 generally), as well as tags (131-1 . . . 131-N) for each data item are determined by inference, deduction or other interpretation of the context.

A tag refers to an output from the model, indicative of the sensitivity but also qualifying it further, such as PII, NPI, financial, legal, etc. Although the attributes apply similarly to tags as a mechanism for qualifying the data, the discussion herein employs attributes as the qualifying values associated with the enriched data 145, and tags 131′ as the resulting conclusion computed by the model 150. In other words, if a data item results in a tag of PII, it is certainly also sensitive.

A shortcoming of the conventional approaches is that reliance on these “matching” methods are simplistic and unreliable. They also don't learn or evolve. They assume that a machine can decide based on simple rules such as regular expressions, which in contrast, are not sufficiently robust.

Conversely, when a human scans data, they can often tell very quickly whether something is sensitive or not, because a human has much more capacity for context and also because a human considers many related aspects. In a human cognitive perception of a number, they typically don't just look at the number. They may look at the name of the file or the table, they may look at what's “around” the number, they many look at the privileges assigned to the table where the number resides or how many people are accessing this table, for example. These contextual aspects are outside the scope of a conventional regex.

Therefore, the disclosed approach is different than previous approaches in at least two aspects:

The enriched data defined herein depicts a “360-degree” view of the assets rather than just the data itself. In other words, it takes the results of the data scan as ONE of the inputs but considers attributes about entitlements and privileges, about who is accessing the data (from audit trails), about how often it changes etc.

2. It does not use fixed rules like matching a regex. Instead, it uses a machine learning approach.

The disclosed machine learning approach employs two components-training a model using known data and attributes, followed by model invocation on live data. In the first component, all of this 360-degree view data is presented to real humans/users, usually the application or data owners. These people know this data robustly and therefore when they look at the data they know with very high certainty if the data is sensitive or not and what classification tags it should have.

The users look at this data and are presented with all the metadata and attributes from all sources. They then mark up the finding as sensitive or not 130, and may also provide a set of labels/tags 131 (e.g. PII, financial, etc.)

These Y/N sensitivity 130 answers and tags 131 are collected for a training period of 1-4 months until there is a diverse and varied data set. This data, including the enriched data set 100 and the corresponding determination and tags, is then used as a training set to train a machine learning model 150. Configurations herein create a random forest but it can also be a neural network or any other model type.

Invocation of the model 150 on live (e.g. non-training) data includes enriching the data 140 with the attributes 120 to build enriched data 145, and applying the model 150 to obtain the sensitivity 130′ and optional tags 131′. Once this model 150 is trained, the model can decide and mark up future findings on whether they are sensitive or not and what are the appropriate tags, based on the enriching attributes 120 obtained for the enriched data set 145.

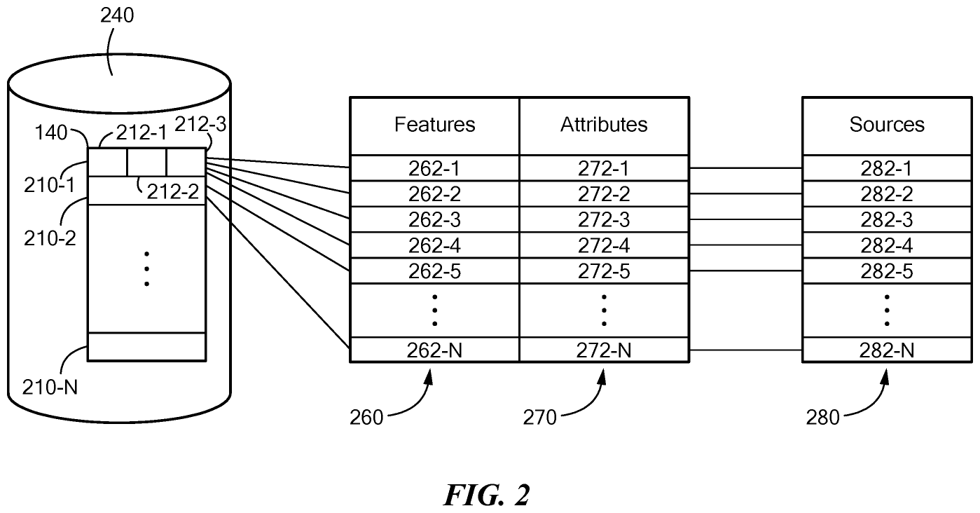

FIG. 2 is a data structure diagram of enriched data depicted in FIG. 1. Referring to FIGS. 1 and 2, a data repository 240 suitable for storing a set of data items 140 includes live production data, typically in a database arrangement such as relational, XML (Extensible Markup Language), JSON (Javascript Object Notation) or other representation suitable for defining fields and values. A data item 140, as employed herein, may include a row 210-1 . . . 210-N (210 generally) or document, or an individual field 212-1 . . . 212-N (212 generally). The size of a data item 140 may be of any suitable granularity, depending on the unit designated for sensitive data (i.e. an address, social security number, contractual document, etc.). Often the number of data items is substantial, as the benefits of the disclosed approach are readily scalable.

The disclosed approach generates a feature set 260 for each data item, such that the feature set includes an entry 262-1 . . . 262-N (262 generally) for each feature of the set and a corresponding attribute set 270 including attributes 272-1 . . . 272-N (272 generally) indicating a tendency the data item defines sensitive or private information. A data item 140 may have any suitable number of features associated with it, and may be stored as a row extension or list indexed from the data item to which it pertains. For each of the features 262, a source 282-1 . . . 282-N (282, generally) indicative of an attribute for the feature is identified. The attribute, typically a “0” or “1” indicating a presence or absence, or alternatively a mnemonic or numeric value may be employed. The attribute is retrieved from the source 280 and stored in conjunction with the data item to define the corresponding feature 262. The set or collection 240 of data items, in conjunction with the attributes 270 defining the features 260, collectively form the enriched data that the model 150 operates on to compute a sensitivity 130 and optionally, one or more tags 131 that qualify or augment the sensitivity. In some contexts, it may be sufficient to compute only the sensitivity 130.

In an example configuration, the features 260 that may be defined for the enriched data set include the following, for which attributes 270 (attribute values) may be determined:
Data pattern (e.g. which regex “hit”)
Length of the data
Cardinality of the data (e.g. how many distinct values in the column)
Which users and roles have access and what type of access
Frequency of data access
Frequency of data changes
Age of the data
What SQL verbs are used to access, change or change metadata
How many distinct client connections access this data
Bitmap on when connections that access this data are made (e.g. every hour, once ins a whiel etc)
Time periods that this data is accessed (e.g. only working hours or all the time)
Frequency this data is accessed
Periodicity this data is accessed (e.g. is it consistent or sporadic)
What errors occur related to this data (e.g. unprivileged access)
How many times have privileges on this table or column changed over the last month or year

The sources 280 from which the attributes may be determined include facilities such as:
Scanned data—scanners pull data and compare with fixed rules such a regex matching or by comparing the data to a fixed list. They also compare table names or column names to patterns (e.g. does the table name have the word CUSTOMER in it or does the column name have the pattern NAME in it). They then emit a “finding” which is the table name, column name, data value itself and what rule it matched, plus the instance specifier (what database was scanned)
Privilege data—return the users and roles that can access this table and column plus whether access is read-only or read-write
Audit data—which accounts access this data, how often, at which time, when was the data first created, when changed etc.

In operation, the enriched, or “360 degree” data results from aggregating the data and the corresponding feature set 260. Once the model 150 is trained, subsequent data items 140 may be enriched, and the model 150 invoked to generate the sensitivity 130′ and tags 131′.

It should be noted that referencing the source 280 may include information about the source itself or information retrieved from the source. For example, the location or exitance of a table at a particular source, or the name of the table or fields within in, may provide inferences about the data. For example, in a credit card or financial table, a numerical format of 123-45-6789 in the same table as a CUSTOMER or NAME field may be likely to indicate a social security number. In an inventory context, this might just be a model or part number having a string format with coincidental similarity (regex approaches fail here). Accordingly, determining an attribute value may further include determining a attribute value based on the storage location of the data. Other factors may include identifiable privileges applied to the data, as a closely guarded or restricted table/field is more likely to contain sensitive data. Other factors may include an access frequency of the data, or formatting characters embedded in the data value. For example, an individual's name usually only changes with infrequent events such as marriage and divorce. In contrast, a bank account balance regularly fluctuates. Similarly, a decimal followed by two numeric digits, and of course a currency reference such as “$” or “USD” in either a field value or label likely denotes money.

The data of FIG. 2 may be stored and retrieved by a data sensitivity classification server, including an interface to a repository 240 of data items, such that each of the data items has at least one feature indicative of confidential, secret, or proprietary information in the data item, and an interface to a plurality of sources 280, such that the interface is configured to receive, from each of the sources 280, an attribute 272 indicative of a likelihood that a particular data item 140 contains sensitive data. The server is configured for invoking the model 150 of the features and attributes for computing whether the data item is a sensitive data item 130′.

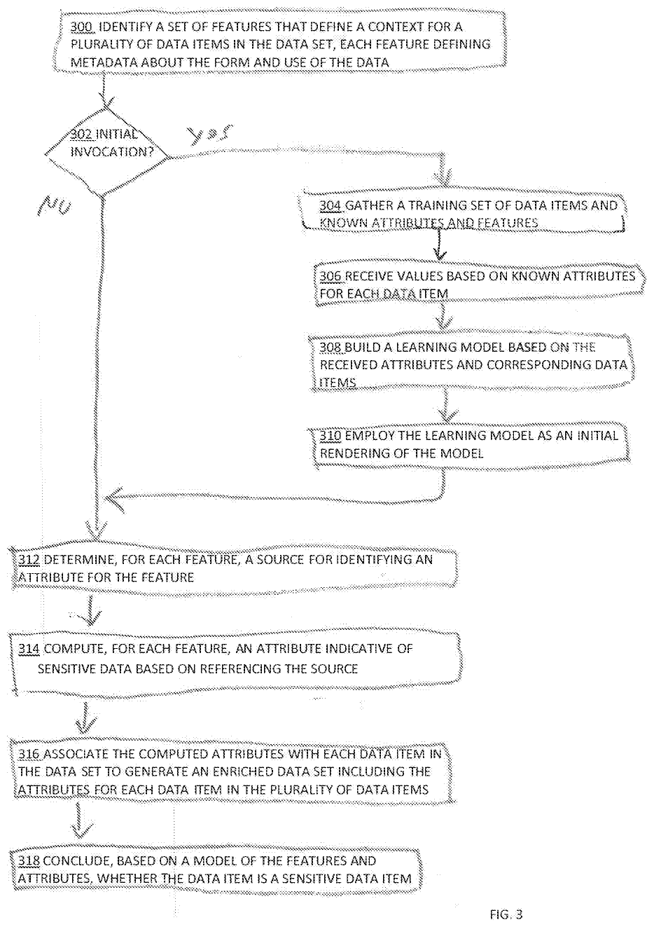

FIG. 3 is a flowchart for developing and invoking the enriched data of FIG. 2. Referring to FIGS. 1-3, at step 300 the method for classifying data in large data sets includes identifying a set of features 260 that define a context for a plurality of data items 140 in the data set, such that each feature 262 defines metadata about the form and use of the data. The features include context and metadata associated with the data, as indicated above, that tend to have a bearing on the sensitivity, particularly in conjunction with other data items.

A check is performed, at step 302, to determine an initial invocation. In the example arrangement, employing a random forest implementation of machine learning, the logic representing the sensitivity classification logic includes the training set 100 used to train the model 150. The model 150 is built by gathering a training set of data items and known attributes and features, as depicted at step 304, and receiving values 105 based on known attributes for each data item, as shown at step 306. The training set 100 typically involves known attributes which are associated with the data items for exemplifying the associations and conclusions that the model 150 should embody with production (i.e. non-training) data. The training set 100 may result from manually deriving attributes based on human inputs about the training data items 110 that denote an accurate classification. The learning model is built based on the received attributes 120 and corresponding data items 110, as disclosed at step 308. The learning model is them employed as an initial rendering of the model 150, which may be retrained as needed to respond to changes in data or recurring inappropriate classifications.

The model can be improved over time—i.e. once the model is tagging data owners can still review the results and if they see an error re-mark the result and rerun the model build. Therefore, there is also a path to incrementally improve the model.

Once initially trained, the model 150 is invoked for determining, for each feature 262, a source 282 for identifying an attribute 272 for the feature, as depicted at step 312. A variety of sources 280 in conjunction with the data items 140 may be consulted, as discussed in FIG. 2. A server, application or similar computing appliance executing the model 150 computes, for each feature 262, an attribute 272 indicative of a sensitivity of the data item based on referencing the source 280, as disclosed at step 314. This may include retrieving metadata from the source, or other information that fulfils the attribute, such as access frequency, audit trails, privileges, and other features discussed above. In contrast to conventional approaches, which focus on quantifications such as percentages, the ML model provides an association of features defined by attributes that tend to suggest sensitivity of the data item. In contrast to conventional approaches, which employ regex quantification to partition groups along a single dimension, the ML model computes many attributes as “indicators” and then employs the machine learning model that has been trained with many examples (attributes) and corresponding answers (true sensitivity).

The enriched data set 145 is generated by associating the computed attributes 272 with each data item 140 in the data set 240 to generate the enriched data set 145 including the attributes for each data item in the plurality of data items. The resulting enriched data set 145 has attributes 262 associated with each row 210, document or field (depending on granularity) in the data set 240, as shown at step 216. In implementation, this may be represented by an extension of each row in a relational arrangement, or simply by a list or pointer addition from each data item 140 to which the attributes apply. Other aggregational data structures may be employed.

The server or computing appliance invokes the model 150 employs the enriched data set for concluding, based on the model of the features 260 and attributes 270, whether the data item is a sensitive data item 130′, and may also output tags 131′ that further refine the sensitivity, such as PII, NPI, financial, or other tag that denotes a particular aspect of sensitivity.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASIC s), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

1. A method for classifying data in large data sets, comprising:
gathering a training set, the training set of data items and known attributes and features;
receiving known attributes for the features of each data item based on gathered contextual information;
building a learning model based on the received known attributes and corresponding data items; and
employing the learning model as an initial rendering of a model, the model of the features and attributes;
identifying a set of features that define a context for a plurality of data items in the large data set, each feature of the set of features defining metadata about a form and use of the data;
determining, for each feature, a source for identifying an attribute for said each feature;
computing, for each feature, a value for identifying the attribute indicative of a sensitivity of each of the plurality of data items based on referencing the source;
associating the value computed for the identified attributes with each data item in the data set to generate an enriched data set including the attributes for each data item in the plurality of data items, the attributes external to the data set and indicative of a greater or lesser likelihood that a data item contains sensitive or private data; and
concluding, based on the model defining metadata indicating a form and use of the plurality of data items, whether each of the plurality of data items is a sensitive data item.

2. (canceled)

3. The method of claim 1 further comprising generating the training set by:
identifying, for each data item, features that define a contextual aspect of the data, each feature tending to have a correlation with sensitivity or privacy of the data; and
for each feature, receiving an attribute previously associated with a sensitivity of each of the plurality of data items.

4. The method of claim 3 wherein the sensitivity indicates a likelihood that each of the plurality of data items is indicative of a personal, unique or financial fact about an entity to which it pertains.

5. The method of claim 1 further comprising generating a feature set for each data item of the plurality of data items, the feature set including an entry for each feature of the feature set and an attribute indicating a tendency that the data item defines sensitive or private information.

6. The method of claim 1 further comprising identifying a source indicative of an attribute for each said feature; and
retrieving the attribute; and
storing the attribute in conjunction with each of the plurality of data items.

7. The method of claim 1 wherein referencing the source includes information about the source itself or information retrieved from the source.

8. The method of claim 1 wherein computing the value for the attribute further comprises determining the attribute based on the storage location of the data.

9. The method of claim 1 further comprising computing the value for the attribute based on privileges applied to the data.

10. The method of claim 1 further comprising determining the attribute based on a string format on formatting characters embedded in the data.

11. The method of claim 1 further comprising determining the attribute based on an access frequency of the data.

12. The method of claim 5 further comprising aggregating each of the plurality of data items and the corresponding feature set for generating the enriched data set, the model responsive to the enriched data set.

13. The method of claim 3 further comprising training the model by receiving attributes based on correct recognition of sample data.

14. A device, the device for data sensitivity classification, comprising:
a training set, the training set of data items and known attributes and features;
an interface for receiving known attributes for the features of each data item based on gathered contextual information;
a processor for building a learning model based on the received known attributes and corresponding data items; and
the processor configured to employ the learning model as an initial rendering of a model, the model of the features and attributes;
a data structure and processor responsive to the model, and an interface to a server farm for training and classifying data items according the model;
an interface to a repository of the data items, each of the data items having at least one feature indicative of confidential, secret, or proprietary information in each of the data items;
an interface to a plurality of sources, the interface configured to receive, from each of the plurality of sources, an attribute indicative of an inclusion of sensitive data in each of the data items;
the model based on a plurality of the features denoting which attributes of the at least one features are an indication that each of the data items is likely to contain sensitive information, the attributes external to the training set and indicative of a greater or lesser likelihood that a data item contains sensitive or private data; and
a server configured for invoking a model of the at least one features and attributes for computing whether each of the data items is a sensitive data item, based on the model defining metadata indicating a form and use of the plurality of data items.

15. The device of claim 14 wherein the training set includes known attributes for the at least one features of each data item based on gathered contextual information, the training set operable for building an initial rendering of the model.

16. The device of claim 15 wherein the training set includes attributes based on correct recognition of sample data.

17. The device of claim 14 wherein the data sensitivity indicates a likelihood that each of the data items is indicative of a personal, unique or financial fact about an entity to which it pertains

18. The device of claim 14 further comprising a feature set for each of the data items, the feature set including an entry for each feature of the set and an attribute indicating a tendency that each of the data items defines sensitive or private information.

19. The device of claim 14 further including an enriched data set including, for each of the data items, an aggregation of the data item and the corresponding features, the model responsive to the enriched data set.

20. A computer program embodying program code on a non-transitory medium that, when executed by a processor, performs steps for implementing a method of classifying data sensitivity in a data set, the method comprising:
gathering a training set, the training set of data items and known attributes and features;
receiving known attributes for the features of each data item based on gathered contextual information;
building a learning model based on the received known attributes and corresponding data items; and
employing the learning model as an initial rendering of a model, the model of the features and attributes;
identifying a set of features that define a context for a plurality of data items in the data set, each feature of the set of features defining metadata about a form and use of the data items;
determining, for each feature, a source for identifying an attribute for said each feature;
computing, for each feature, an attribute indicative of a likelihood that each of the plurality of data items contains sensitive data based on referencing the source;
associating a respective attribute of the computed attributes with each data item in the data set to generate an enriched data set including the attributes for each data item in the plurality of data items, the attributes external to the data set and indicative of a greater or lesser likelihood that a data item contains sensitive or private data; and
concluding, based on the model defining metadata indicating a form and use of the plurality of data items, whether each of the plurality of data items is a sensitive data item.

21. (canceled)
